(19) United States
(12) Patent Application Publication
(10) Pub. No.: US 2005/0244707 A1
(43) Pub. Date: Nov. 3, 2005

(54) Metal halide redox flow battery

(76) Inventors: Maria Skyllas-Kazacos, New South Wales (AU); Michael Kazacos, New South Wales (AU); Asem Mousa, Victoria (AU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/512,417

(22) PCT Filed: Apr. 23, 2003
(86) PCT No.: PCT/GB03/01757

§ 371 Date: Jun. 10, 2005

(30) Foreign Application Priority Data
Apr. 23, 2002 (AU) PS 1921

(51) Int. Cl. H01M 8/20; H01M 10/44; H01M 4/86; H01M 4/96

(52) U.S. Cl. 429/105; 429/50; 429/199; 429/42; 429/44

(57) ABSTRACT

A 3 M V(IV) bromide solution in 3-4 M HBr or HBr/HCl mixture is added to both sides of the redox flow cell or battery. On fully charging the cell, the vanadium (IV) bromide solution is reduced to produce 3M VBr₂ in the negative half-cell, while the bromide ions in the positive half-cell are oxidised to produce 1.5 M Br₃— or ClBr₂. On discharge, the VBr₂ is oxidised to VBr₃ in the negative half cell while the Br₃ or ClBr₂— ions are reduced to Br ions in the positive half cell. The cell comprises carbon or graphite felt bonded onto plastic or conducting plastic sheets as substrate materials and the two half cells are separated by an anion or cation exchange membrane.

The present invention relates to a vanadium redox flow battery.

A redox flow cell comprises a positive compartment and a negative compartment. The electrolyte in the positive half-cell is in electrical contact with a positive electrode. The combination of the positive compartment, the electrolyte and the positive electrode is referred to as the “positive half-cell”. The electrolyte in the negative half-cell is in electrical contact with a negative electrode. The combination of the negative compartment, the electrolyte and the negative electrode is referred to as the “negative half-cell”. The electrolyte in the positive compartment and the electrolyte in the negative compartment are separated by an ionically conducting separator, typically an ion exchange membrane, to provide ionic communication between the electrolyte in the positive compartment and the electrolyte in the negative compartment.

In U.S. Pat. No. 4,786,567, whose inventors include the present inventor Maria Skyllas-Kazacos, there is described and claimed:

An uncharged all-vanadium redox battery having a positive compartment containing a catholyte in electrical contact with a positive electrode, said catholyte comprising an electrolyte containing tetravalent vanadium ions, a negative compartment containing an anolyte in electrical contact with a negative electrode, said anolyte comprising an electrolyte containing trivalent vanadium ions, and an ionically conducting separator disposed between said positive compartment and said negative compartment and in contact with said catholyte and said anolyte to provide ionic communication therebetween and wherein said catholyte includes a salt of the formula VO(X)Y where y is 2 and X is selected from F, Br or Cl or y is 1 and X is selected from SO4 or O and the concentration of said salt is from 0.25M to 5.0M. This patent is known as the “All-Vanadium Patent”

In a redox “flow” battery, the catholyte and anolyte is circulated or flows through the compartments.

It should be noted that the terms “battery” and “cell” are variously used in the art with the same meaning. They are used synonymously in this specification.

More generally, a redox flow cell allows energy to be stored in two solutions containing different redox couples with electrochemical potentials sufficiently separated from each other to provide an electromotive force to drive the oxidation-reduction reactions needed to charge and discharge the cell. Of the redox flow cells developed to date, the all-vanadium redox flow cell of the above U.S. patent has shown long cycle life and high energy efficiencies of over 80% in large installations of up to 500 kW in size. The main advantages of the vanadium redox flow battery are associated with the use of the same element in both half-cells which avoids problems of cross-contamination of the two half-cell electrolytes during long-term use. While the performance characteristics of the all-vanadium redox flow battery have made it well suited to stationary applications, its relatively low energy density has to date limited its use in electric vehicle or other mobile applications.

The factors that determine the energy density of a redox flow battery are the concentration of the redox ions in the electrolyte in both half-cells, the cell potential and the number of electrons transferred during discharge per mole of active redox ions. In the case of the all-vanadium redox flow cell, the maximum vanadium ion concentration that can be employed for wide temperature range operation is typically 2 M or less. This concentration represents the solubility limit of the V(II) and/or V(III) ions in the sulphuric acid—H₂SO₄—supporting electrolyte at temperatures below 5° C. and the stability of the V(V) ions at temperatures above 40° C.

Studies with hydrochloric acid—HCl—supporting electrolyte, however, have shown that V(III) and/or V(III) ion concentrations as high as 4 M could be achieved in a chloride system. HCl is unsuitable as a supporting electrolyte for the positive half-cell of the all-vanadium redox battery however, due to the fact that V(V) ions are reduced by the chloride ion giving rise to chlorine gas evolution and the formation of V(IV). International application PCT/AU02/01157 (unpublished at the priority date of the present application and another invention of Maria Skyllas-Kazacos) describes and claims:

A redox flow cell comprising a positive half-cell and a negative half-cell, the positive half-cell containing an electrolyte containing a polyhalide/halide redox couple, and the negative half-cell containing an electrolyte containing the V(III)/(II) redox couple.

This application is known as the “Polyhalide Patent”

However, it has been discovered that this cell degrades by cross-contamination, i.e. migration of ions between the half-cells.

It has now been understood that by use of the same metal in both half-cells—but without relying on it for the redox reaction in the positive half-cell—the disadvantage of cross-contamination can be alleviated.

One object of the present invention is to provide an improved vanadium redox flow battery.

Further studies have revealed that other bromide-based redox flow cells based on other soluble metal cations are also feasible. In such a metal bromide redox flow cell the same electrolyte is employed in both half-cells, thus eliminating any problems of cross-contamination by diffusion of ions across the membrane.

Certain terminology is used in common with the polyhalide patent. Thus in the following statement of invention and throughout this specification:

The term “polyhalide” means any ion consisting of three or more halogen atoms, such as Br₃⁻, ClBr₂⁻, BrCl₂⁻. A polyhalide is formed by the complexing reaction between a halogen molecule and a halide ion. For example:

Br₂+Br⁻ [symbol] Br₃

Br₂+Cl⁻ [symbol] ClBr₂⁻

Cl₂+Br⁻ [symbol] BrCl₂⁻

The formation of the polyhalide ion allows the halogen molecule to be completed so that it does not escape from solution as a gaseous product. It should be noted that the polybromide Br₃⁻ is also referred to as a halide.

The term “redox couple” means a combination of a reduced and an oxidised form of a particular ion or neutral species, that, in a supporting electrolyte in a half-cell of a redox flow cell, undergoes oxidation from the reduced form to the oxidised form during the charging and discharging of the redox fuel cell and undergoes reduction from the oxidised form to the reduced form during the discharging or charging of the redox flow cell. As will be appreciated by persons skilled in the art, in a fully charged or discharged redox flow cell, all or substantially all of the redox couples in each half-cell may be in the reduced or the oxidised form. As used herein, the term “redox couple” encompasses the situation where all or substantially all of the redox couple is present in the oxidised or the reduced form, as well as the situation where some of the redox couple is present in the oxidised form and the remainder is present in the reduced form.

The term “V(III)/V(II) redox couple” means the redox couple consisting of the V³⁺ and V²⁺ ions.

The term “two valency state” means, in respect of a metal, that the metal has two stable valency states, such as cuprous and cupric copper. Metals having more than two stable valency states are included within this meaning.

The term “halide redox couple” means a redox couple consisting of a complex halide or polyhalide ion and the corresponding halide ions.

The term “polyhalide/halide redox couple” means a redox couple consisting of a polyhalide ion and the corresponding halide ions.

The term “electrolyte” means a solution which conducts current through ionisation.

The term “supporting electrolyte” means an electrolyte capable of supporting the oxidised and reduced forms of a redox couple, and corresponding cations and anions to balance the charge of the redox ions, in solution during the oxidation and reduction of the redox couple. The supporting electrolyte also provides additional ions in solution to increase the conductivity of the solution and support the flow of current in the cell. It may also form ion pairs or complexes with the electroactive ion to enhance its electrochemical activity and solubility.

According to a first aspect of the invention, there is provided:

A metal halide redox flow cell comprising:

a negative half-cell having:
an electrolyte containing a two valency state metal redox couple and

a positive half-cell having:
an electrolyte containing halide redox couple;
   wherein the positive half-cell electrolyte also contains:
a halide of the said metal to provide substantial equilibrium of metal ion migration between the half cells.

Preferably, the metal is vanadium and the two valency state metal redox couple is the V(II)/(III) couple.

Alternative metals and their negative half-cell redox couples are:

| | |
|---|---|
| Copper | Cu(I)/Cu(II), |
| Molybdenum | Mo(II)/Mo(III), |
| Manganese | Mn(II)/Mn(III), |
| Tin | Sn(II)/Sn(IV) and |
| Titanium | Ti(III)/Ti(IV). |

The negative half-cell reactions at the negative positive electrode of vanadium and copper for instance as two valency state metal redox couple are:

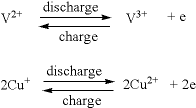

Preferably, the halide redox couple comprises bromine.

The polyhalide/halide redox couple preferably incorporates bromide. Preferably they comprise one or more (as mixtures) of the following polyhalide/halide redox couples selected from those identified in the polyhalide patent, namely

Br₃⁻/Br⁻,

ClBr₂⁻/Br⁻,

BrCL₂⁻/CL⁻.

The cells of the invention incorporating these polyhalide/halide redox couples are referred to herein a vanadium bromide cells.

The corresponding positive half-cell reactions at the positive electrode of these preferred polyhalide/halide redox couples are:

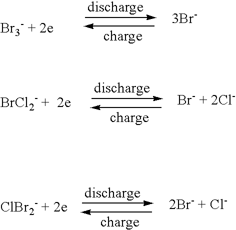

For the polybromide/bromide redox couple, the supporting electrolyte in each redox flow cell can be HBr, NaBr, KBr or mixtures thereof in a concentration range from 0.1 to 12 M or 0.1 to 8 M.

For the mixed polyhalide/halide redox couples from 0.5 to 6 M. HCl, NaCl or KCl can be added to the HBr, NaBr, KBr or mixtures thereof in the supporting electrolyte to form stable polyhalides with the bromine that is formed in the positive half-cell during charging.

The concentration of the vanadium bromides in the negative and positive half-cell electrolytes of the vanadium bromide redox flow cell can be 0.1 to 6 M but is typically from 0.5 to 5 M or 1 to 5 M and preferably 1 to 4 M.

The concentration of the Br₃⁻, Br₂Cl⁻ and/or Cl₂Br⁻ ions in the positive half cell of the fully charged vanadium bromide redox flow cell can be 0.1 to 5 M or 0.5 to 5 M or preferably 1 to 3 M or 1 to 2 M.

The metal bromide redox flow cell thus employs a solution of 0.1 to 5 M metal bromide in both half-cells. The electrolyte solution that is initially placed in both half-cells of the metal bromide redox cell more typically comprises 0.5 to 5 M metal bromide in a supporting electrolyte of 0.5 to 10 M HBr, or more typically 0.5 to 5 M HBr. The electrolyte solution can also contain chloride ions at a concentration of 0.1 to 5 M, or more typically 0.5 to 2 M in 0.5 to 10 M HBr, NaBr, KBr or mixtures thereof.

The vanadium bromide redox flow cell thus employs a solution of 0.1 to 5 M vanadium bromide in both half-cells.

Typically, a solution of 0.1 to 5 M V(IV) bromide in a supporting electrolyte of HBr, NaBr, KBr or mixtures thereof, is initially placed into each half-cell. The concentration of supporting electrolyte can be of 0.5 to 10 M HBr, NaBr, KBr or mixtures thereof. The electrolyte solution can also contain chloride ions at a concentration of 0.1 to 5 M.

In its discharged state, the metal bromide cell comprises a negative half-cell with a solution of the oxidised form of the metal cation in a supporting electrolyte selected from the group comprising HBr, NaBr, KBr or mixtures thereof and a positive half-cell comprising the oxidised form of the metal cation in a supporting electrolyte selected from the group comprising HBr, NaBr, KBr or mixtures thereof. The discharged positive and negative half-cell electrolytes can also contain chloride ions at a concentration of 0.1 to 5 M.

During cycling of the cell, the negative half-cell electrolyte comprises the metal cation in its oxidised and/or reduced form and the positive electrolyte comprises a bromide/polyhalide couple in the presence of the metal ions. More typically, during cycling, the negative half-cell electrolyte contains the metal bromide in a supporting electrolyte selected from the group HBr, NaBr, KBr, HCl, NaCl, KCl or mixtures thereof Even more typically, the negative half cell electrolyte solution comprises 0.5 to 5 M metal bromide in 0.1 to 10 M HBr or HCl/HBr or NaCl/HBr or KCl/HBr mixtures.

The charged or partially charged positive half-cell of the vanadium bromide redox flow cell contains an electrolyte solution of the metal ions and one or more of the redox couples selected from the group Br⁻/Br₃⁻, Br⁻/Br₂Cl⁻ or mixtures thereof. In the discharged state, the metal bromide redox flow cell contains a positive half-cell electrolyte solution that includes metal ions in a mixture of Cl⁻ and Br⁻ of total concentration 1 to 12 M. In the charged or partially charged state, the positive half-cell electrolyte includes metal ions in a solution containing 0.5 to 5 M Br₃⁻ or Br₂Cl⁻ ions or mixtures thereof.

A typical negative half-cell electrolyte solution for the metal bromide redox flow cell comprises 0.5 to 5 M MBr in a supporting electrolyte of HBr, NaBr, KBr or mixtures thereof, where M denotes the metal cation in its oxidised or reduced form, The negative half-cell electrolyte solution can also contain Cl⁻ ions at a concentration of 0.1 to 5 M. More typically, the excess bromide and chloride ion concentration the negative half-cell electrolyte is 0.1 to 10 M or more typically 0.1 to 5 M.

The discharged or partially charged positive half-cell electrolyte solution for the MBr redox flow cell typically comprises M cations in a supporting electrolyte of HBr, NaBr, KBr or mixture thereof. More typically, the positive half-cell electrolyte solution contains 0.5 to 5 molar M cations in a mixture of 0.5 to 12 M bromide and chloride ions.

The two half-cell electrolytes are separated by an ion exchange membrane which prevents the bulk mixing of the 2 solutions as they are pumped through the cell or cell stack. The ion exchange membrane can be a cation exchange membrane which would allow the transfer of the charge carrying H⁺, Na⁺ and/or K⁺ ions depending on the composing of the supporting electrolyte. If an anion exchange membrane is used, then charge transfer could be via either the H⁺ Br⁻ and/or Cl⁻ ions. Typically, the ion exchange membrane is a cation exchange membrane such as Gore Select P-03430 or other Gore Select membrane, a Flemion membrane or a Selemion CMV membrane or an anion exchange membrane such as Tokuyama AFN-R anion exchange membrane. Other suitable membranes could also be used, the requirement being good chemical stability in the MBr/bromine solution, low electrical resistivity and low permeability for the polybromide ions in the positive half-cell and the reduced metal ions in the negative half-cell electrolytes.

The negative and positive electrode materials for the MBr redox flow cell is typically porous carbon or graphite felt, matte or cloth materials on a graphite, glassy carbon or conducting plastic substrate. The positive electrode material can also be an oxide coated titanium metal sheet or expanded metal mesh. The titanium based electrode would provide greater long term stability against oxidation during charging of the positive half-cell solution.

The two half-cell electrolytes are stored in external tanks and are pumped through the cell stack where the charging and discharging reactions occur. The electrolytes can be electrically charged by connecting the cell or battery terminals to a suitable power source, but can also be mechanically refueled by exchanging the discharged solutions with recharged solutions at a refueling station in the case of electric vehicle applications.

To discharge the battery, the stack terminals are connected to a load and when the circuit is closed, electricity is produced by the flow of electrons from the negative terminal to the positive terminal of the cell or battery stack. Charging and discharging can be carried out either with the pumps switched on and the electrolytes recirculating through the external tanks and cell stack, or with the pumps off, allowing the solution in the stack itself to undergo discharge reactions. Periodically the two solutions may be remixed to produce the original MBr electrolyte in both tanks. This allows any chemistry imbalance arising from the transfer of ions across the membrane to be corrected, so that the capacity of the system can be restored.

In the discharged state of the vanadium bromide cell, it comprises a negative half-cell with a solution of V(II) and/or V(IV) ions in a supporting electrolyte selected from the group comprising HBr, NaBr, KBr or mixtures thereof and a positive half-cell with a solution of V(IV) and/or V(V) ions in a supporting electrolyte selected from the group comprising HBr, NaBr, KBr or mixtures thereof. The discharged positive and negative half-cell electrolytes can also contain chloride ions at a concentration of 0.1 to 5 M.

During cycling of the cell, the negative half-cell electrolyte comprises V(II), V(III) and/or V(IV) ions and the positive electrolyte comprises a bromide/polyhalide couple in the presence of V(IV) and/or V(V) ions. More typically, during cycling, the negative half-cell electrolyte contains VBr₂ and/or VBr₃ in a supporting electrolyte selected from the group HBr, NaBr, KBr, HCl, NaCl, KCl or mixtures thereof. Even more typically, the negative half cell electrolyte solution comprises 0.5 to 5 M VBr₃ and/or VBr₂ in 0.1 to 10 M HBr or HCl/HBr or NaCl/HBr or KCl/HBr mixtures

The charged or partially charged positive half-cell of the vanadium bromide redox flow cell contains an electrolyte solution of vanadium ions and one or more of the redox couples selected from the group Br⁻/Br₃⁻, Br/Br₂Cl⁻ or mixtures thereof. In the discharged state, the vanadium bromide redox flow cell contains a positive half-cell electrolyte solution that includes vanadium ions in a mixture of Cl⁻ and Br⁻ of total concentration 1 to 12 M. In the charged or partially charged state, the positive half-cell electrolyte includes vanadium ions in a solution containing 0.5 to 5 M Br₃⁻ or Br₂Cl⁻ ions or mixtures thereof.

A typical negative half-cell electrolyte solution for the vanadium bromide redox flow cell comprises 0.5 to 5 M VBr₂ and/or VBr₃ in a supporting electrolyte of HBr, NaBr, KBr or mixtures thereof. The negative half-cell electrolyte solution can also contain Cl ions at a concentration of O.1 to 5 M. More typically, the excess bromide and chloride ion concentration the negative half-cell electrolyte is 0.1 to 10 M or more typically 0.1 to 5 M.

The discharged or partially charged positive half-cell electrolyte solution for the vanadium bromide redox flow cell typically comprises V(IV) and/or V(V) ions in a supporting electrolyte of HBr, NaBr, KBr or mixture thereof. More typically, the positive half-cell electrolyte solution contains 0.5 to 5 M vanadium ions in a mixture of 0.5 to 12 M bromide and chloride ions.

The two half-cell electrolytes are separated by an ionically conducting separator to provide ionic communication between the electrolytes in the positive and negative half-cells whilst preventing the bulk mixing of the 2 solutions as they are pumped through the cell or cell stack. In theory the separators should isolate the metals in their half-cells, but over a period of time migration occurs. By providing the same metal on both side of the separator, the random migrations balance each other over an extended period. Preferably the separator is an ion exchange membrane. This can be a cation exchange membrane which would allow the transfer of the charge carrying H⁺, Na⁺ and/or K⁺ ions depending on the composing of the supporting electrolyte. If an anion exchange membrane is used, then charge transfer could be via either the H⁺Br⁻ and/or Cl⁻ ions. Typically, the ion exchange membrane is Nafion 112, Nafion 117 or other Nafion cation exchange membranes. The ion exchange membrane could also be a Gore Select membrane, a Flemion membrane or a Selemion CMV cation exchange membrane. Other suitable membranes could also be used, the requirement being good chemical stability in the vanadium bromide solution, low electrical resistivity and low permeability for the vanadium and polybromide ions in the positive half-cell and the vanadium ions in the negative half-cell electrolytes.

The negative and positive electrode materials for the vanadium bromide redox flow cell is typically porous carbon or graphite felt, matte or cloth materials on a graphite, glassy carbon or conducting plastic substrate. The positive electrode material can also be an oxide coated titanium metal sheet or expanded metal mesh. The titanium based electrode would provide greater long term stability against oxidation during charging of the positive half-cell solution.

In a separate embodiment, the VBr₂/VBr₃ couple is employed in the negative half cell electrolyte while the positive half-cell contains either a solution of Br⁻/Br₃⁻ or a solution of Br⁻/Br₂Cl⁻ or mixtures of the two.

According to a second aspect of the invention there is provided:

A method of producing a metal halide redox flow cell comprising a negative half-cell having an electrolyte containing a two-valency-state metal redox couple and a positive half-cell having an electrolyte containing halide redox couple and a halide of the said metal, the method consisting in the steps of:

adding to both half cells:
a solution of a salt of a halide of the said metal and
a supporting electrolyte comprising hydro-halic acid and/or a salt of one or more Group I metal halide(s) and

charging the cell.

According to a third aspect of the invention there is provided:

An electrolyte solution for use in both half-cells of a vanadium bromide redox flow cell, the solution comprising 0.5 to 5 M V(IV) bromide in a supporting electrolyte of HBr, NaBr, KBr or mixtures thereof.

According to a fourth aspect of the invention there is provided:

A negative half-cell electrolyte solution for a vanadium bromide redox flow cell, comprising 0.5 to 5 M VBr₂ and/or VBr₃ in a supporting electrolyte of HBr, NaBr, KBr or mixtures thereof.

According to a fifth aspect of the invention there is provided:

A positive half-cell electrolyte as claimed in claim 40, wherein the concentration is of 0.5 to 5 M vanadium ions in a mixture of 0.5 to 12 M bromide and chloride ions.

According to a sixth aspect of the invention there is provided:

A method for producing an electrolyte for a vanadium bromide redox, consisting in the steps of mixing of equimolar amounts of a V(111) compound with a V(V) compound in a solution of HBr, NaBr, KBr or mixtures thereof and stirring until fully dissolved.

To help understanding of the invention, a specific embodiment thereof will now be described by way of example and with reference to the accompanying drawings, in which:

FIGS. 1 to 9 are plots of various experimental results in the examples below.

### EXAMPLE 1

A cell employing a Nafion 112 membrane and a solution of vanadium bromide as the active material in both half-cells was set up and evaluated as follows:.

The vanadium(IV) bromide solution was prepared by dissolving vanadium oxides in hydrobromic acid. Hydrochloric acid was added to the solution to provide an excess hydrogen ion concentration whenever needed. It was expected that the vanadium(IV) ions will be oxidised to vanadium(V) during the first charging cycle. The bromide ions in the negative side are expected to be inactive.

FIG. 1 shows the charging and discharging times for the cell containing 1.0 vanadium(IV) bromide in 1.5 M hydrochloric acid. 50.0 mls of the solution was placed in each cell which was initially cycled between 0.8 and 1.8 V by applying a constant current of 1.0 Amp. The volume of the positive side solution was found to decrease after five cycles due to water transfer to the negative side of the cell. Hence 5.0 mls of the original solution was added to the positive side when it was fully discharged. Another addition was made after the twenty fifth cycle (25) due to the drop in the level of the solution in both side of the cell. The addition of the solution was repeated twice at cycle number 36 and 60 as indicated in FIG. 1 by the highlighted areas.

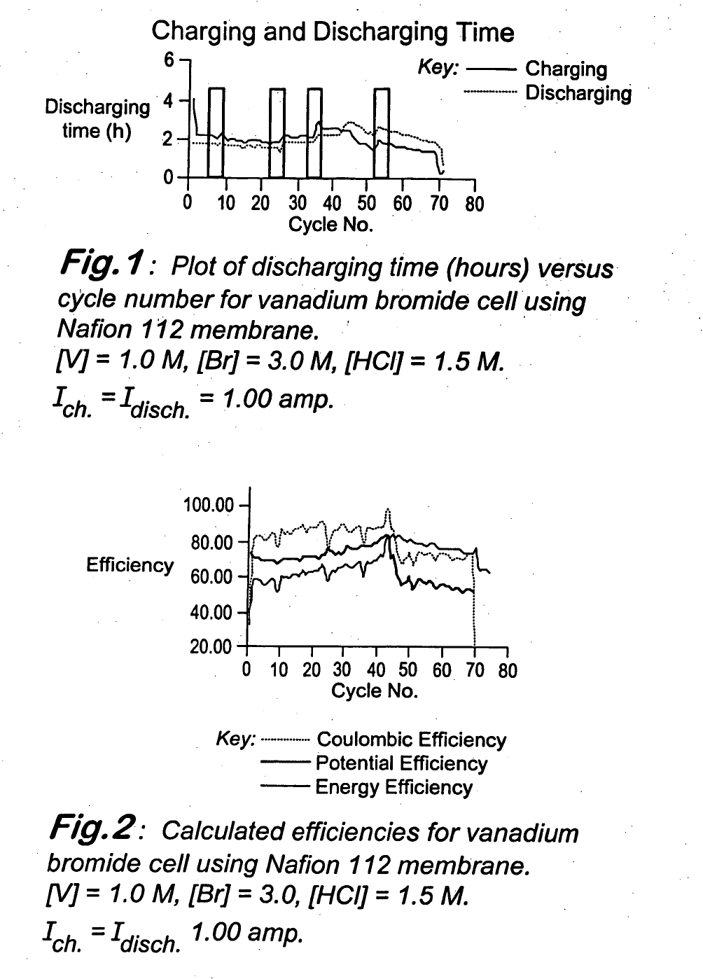

The length of the charging and discharging times showed slight changes during the cycling. The addition of the vanadium(IV) bromide solution while the cell is running disturbs the evaluation of the stability of these times. Nevertheless, the stability of the solution is reflected by the relatively stable coulombic and potential efficiencies of the cell as shown in FIG. 2.

### EXAMPLE 2

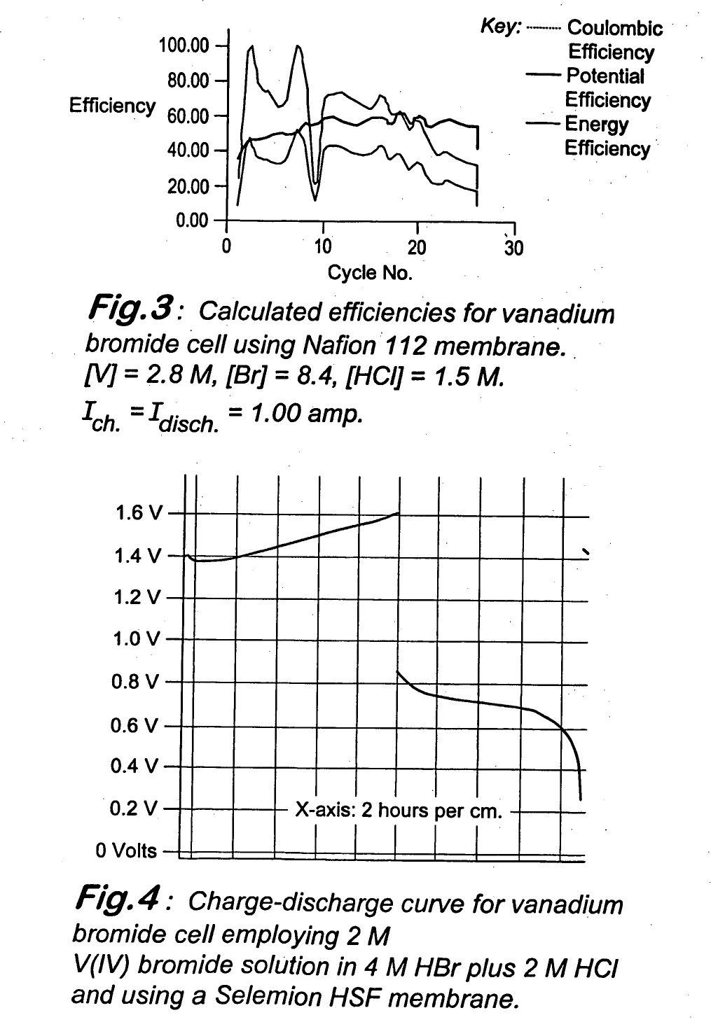

A solution containing 2.8 M vanadium(I) bromide in 2.8 M hydrobromic acid and 1.5 M hydrochloric acid (equivalent to 2.8 M VBr₃ in 1.5 HCl in the discharged negative half-cell) was examined in a flow cell that employed a Nafion 112 membrane. The cell performance showed values of the coulombic, potential and overall efficiencies as shown in FIG. 3.

Some anomalous behavior is observed during cycling as shown by the inconsistencies in the efficiencies values, probably due to the complicated chemistry of these solutions coupled with the migration of solvent and/or ions across the Nafion 112 membrane and the loss of the bromine and water due to evaporation. In particular, a large solution transfer from the positive into the negative half-cell was observed during the charge cycle, this making it very difficult to maintain operation of the cell without the periodic manual transfer of the solution back to the positive half-cell reservoir. When the cell was dismantled, a brown film was also observed on one surface of the membrane, showing that fouling had occurred during charging. The film could be removed by wiping the membrane surface with a tissue, but no further identification of the deposit was made. The results obtained showed that while promising charge-discharge behaviour is possible with the vanadium bromide redox cell, further optimisation of the electrolyte composition and cell components, however, improved performance should be obtained.

### EXAMPLE 3

A solution comprising 2 M vanadium (IV) bromide in 4 M HBr plus 2 M HCl was placed into a redox cell that employed a Selemion HSF membrane (Asahi Glass, Japan) and graphite felt electrodes of 25 cm² area. 70 ml of the solution was placed into each half-cell reservoirs and the pumped through the cell. The cell was charged and discharged for 12 consecutive cycles using a charge-discharge current of 1 or 2 Amps and the cell voltage was recorded as a function of time. FIG. 4 shows a typical charge-discharge curve obtained at a charge-discharge current of 2 Amps. From the ratio of the discharge time to charge time, a coulombic efficiency of 85% can be calculated, showing relatively good performance in the vanadium bromide. The charge and discharge times were recorded for more than 10 cycles and negligible change was observed, highlighting the improved behaviour of this membrane in the VBr solution.

Unlike the Naflon 112 membrane, this Selemion HSF membrane showed negligible transfer of electrolyte from one half-cell to the other during cycling, so that a more steady output was obtained. After about 15 consecutive charge-discharge cycles, however, solution transfer began across the membrane and on disassembly of the cell and inspection of the membrane, blistering was observed on the resin side.

### EXAMPLE 4

A separate cell with 3 M vanadium (IV) bromide and 25 cm² electrode area was evaluated using a Gore Select P-03430 membrane. The cell was cycled at 2 amps for more that 40 cycles and no solution transfer was observed from one half-cell to the other, showing that this membrane has excellent properties in the vanadium bromide redox cell.

### EXAMPLE 5

A 3 M vanadium bromide solution for use in the redox flow cell was prepared by the following method:

1. 0.75 moles of V₂O₅ and 0.75 moles of V₂O₃ powders were weighed into two separate containers.

2. The two powders were slowly to 0.8 litres of a 9-10 M HBr solution in a beaker and stirred for a few hours. A blue V(IV) bromide solution was obtained. The solution can be filtered if required and the volume made up to 1 litre with the HBr solution.

3. The calculated amount of excess acid was then added. This excess acid can be set to any value, but 1.50 M of hydrochloric or hydrobromic acid was used in most of the 3 M V(IV) bromide solutions for the present study.

### EXAMPLE 6

A 4 M V(IV) bromide solution was prepared by mixing 1 mole of V₂O₅ and 1 mole of V₂O₃ powders in a beaker containing 1 litre of 8 M HBr plus 2 M HCl. The powders were stirred for 2 hours until fully dissolved. The resultant blue V(IV) solution was then boiled to bring the final volume to 1 litre.

### EXAMPLE 7

A VBr₃ solution was prepared by the electrolytic reduction of VOBr₂ in hydrobromic acid with the use of an electrolytic batch cell. The electrolytic batch cell was constructed from perspex, employing lead electrodes, and a Nafion membrane as a separator.

Since V₂O₃ is not soluble in the acid, VBr₃ could not be just simply prepared from the dissolution of V₂O₃ in HBr. The reaction between V₂O₃and V₂O₅ powders, however, will result in V(IV) which is very soluble in acid. In this experiment 1 M V(IV) was prepared from the chemical dissolution of V₂O₅ powder and V₂O₃ powder with excess HBr. The dissolution was done in a beaker on the magnetic stirrer (500 rpm stirring speed) with heating (175° C.) for about 1 hour. The reaction involved in this dissolution was:
V₂O₅₍ₛ₎+V₂O₃₍ₛ₎+8HBr₍ₗ₎ [symbol] 4VOBr_{2(aq)}+4H₂O₍ₗ₎

Since the dissolution was done with heating, some bromine gas was produced by the reaction with V₂O₅ which meant there was loss in bromine. Therefore, excess concentration of HBr was used to compensate the loss.

In the preparation of 1 M V(III), the freshly prepared V(IV) was placed into the negative half-cell of the electrolytic cell and the positive half-cell of the electrolytic cell contained 2 M HBr of the same volume as the solution in negative half-cell. During the electrolysis, agitation was provided by nitrogen bubbling in order to keep the vanadium particles in suspension and to provide adequate mass transfer needed by the particles and allow high current efficiencies to be obtained.

A DC power supply was employed to supply the current needed for the electrolysis. In this case the concentration of the 500 mL solution was 1 mol/L and the current applied was 0.85 Amp. When the electrolysis was complete, a dark blue-green solution was formed in the cathodic half-cell.

The following reaction takes place during the electrolytic reduction:
VO²⁺+2H⁺_{(aq)}+e⁻ [symbol] V³⁺_{(aq)}+H₂O₍ₗ₎

During the electrolysis, water was lost from the cathodic half-cell. This was replaced by the addition of distilled water. The loss-of water was due to the evaporation and a small amount of water decomposition, which indicated that the electro-reduction process was not 100% efficient. The exact concentration for the solution was determined by Atomic Absorption Spectroscopy.

The chemical dissolution of vanadium pentoxide in the V(III) solution was carried out by dissolving 15 grams of vanadium pentoxide powder in 1 liter of a solution of 3.5 M of hydrochloric acid and 0.1 M of V(III), which was obtained from the electrolysis process. The reaction was carried out at room temperature with 325 rpm stirring speed using a magnetic stirrer plate. The vanadium powder was discharged into the solution and the timer was started. Samples were taken by 10 mL glass pipettes every 10 minutes for 90 minutes. The samples taken were then stored in sealed sample tubes for further dilution and analysis with atomic absorption spectroscopy.

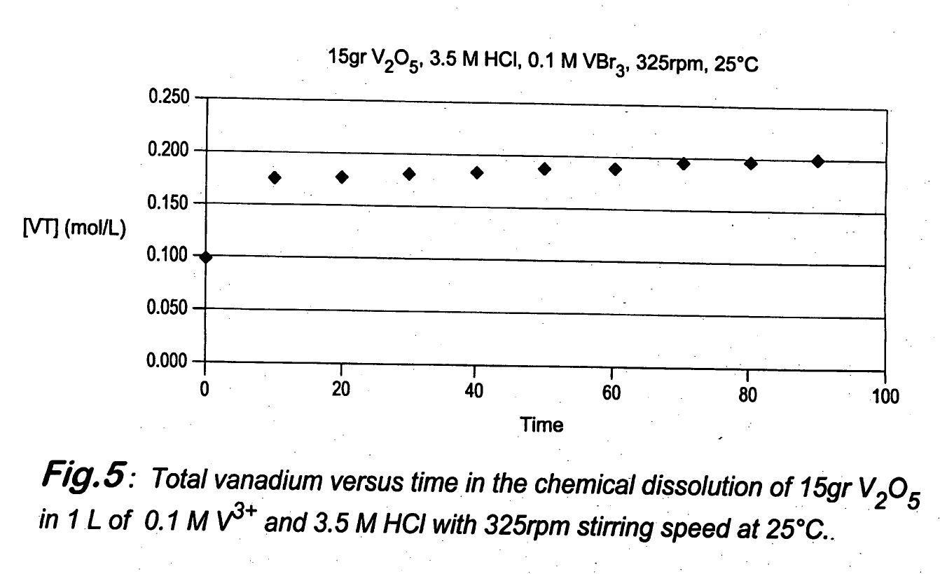

The total vanadium concentration in solution determined by Atomic Absorption Spectroscopy is presented in FIG. 5.

### EXAMPLE 8

More experiments were conducted to establish whether V₂O₅ reacts simultaneously with Cl⁻, Br⁻, and V³⁺. Instead of using a magnetic stirrer, an electric motor stirrer was used to give constant stirring speed. The experimental conditions were as follows:

15 grams of V₂O₅ with 1 L of 3 M HCl,

15 grams of V₂O₅ with 1 L of 3 M HCl and 0.3 M NaBr,

15 grams of V₂O₅ with 1 L of 3 M HCl and 0.1 VBr₃.

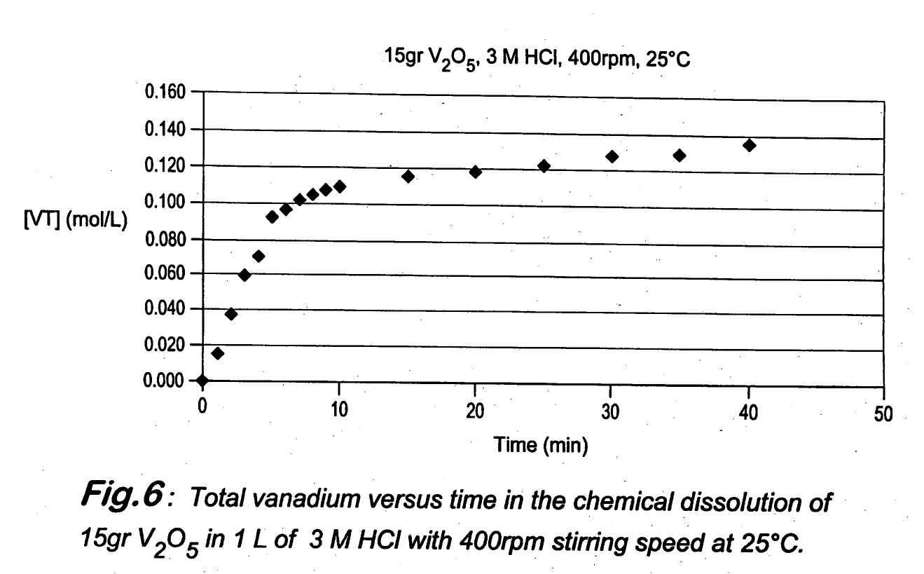

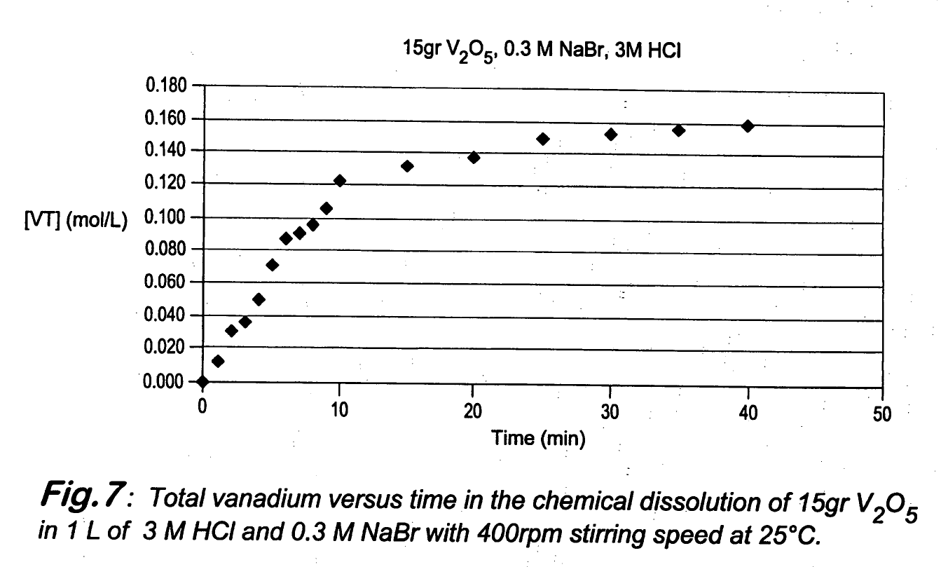

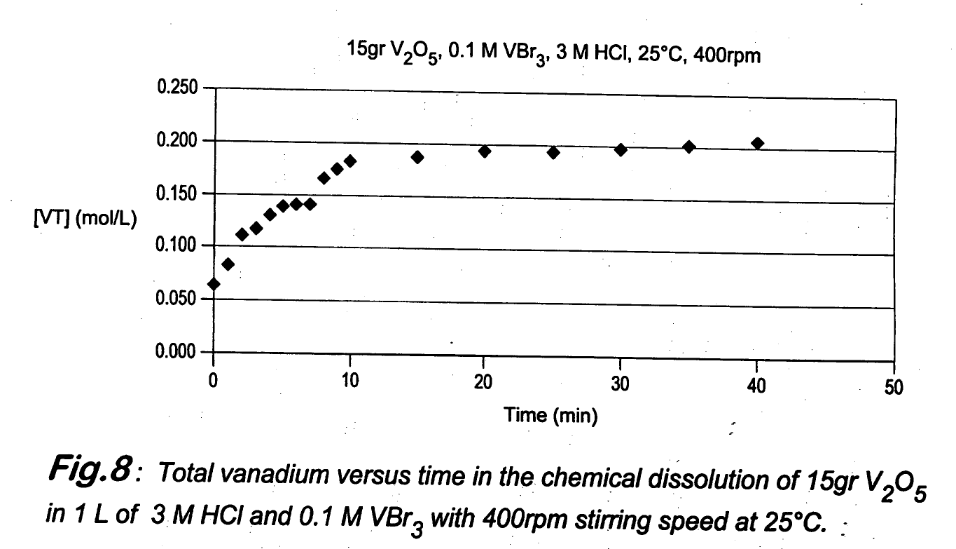

The result of the dissolution of V₂O₅ with only HCl is presented in FIG. 6. This shows that the concentration of vanadium increases significantly in the first 10 minutes and slowly after 10 minutes until the vanadium powder was totally consumed. The same trend is also shown in the dissolution of V₂O₅ in the mixture solution of 3 M HCl and 0.3 M NaBr, which is shown in FIG. 7; as well as the dissolution of V₂O₅ in the mixture solution of 3 M HCl and 0.1 M VBr₃, which is shown in FIG. 8.

These three experiments above show V₂O₅ solid will reacted with B³⁺, Br⁻, Cl⁻ simultaneously, speeding up the dissolution process.

### EXAMPLE 9

The Chemical Dissolution of V₂O₃ in Br⁻ Solution was studied. The bromine solution used in this experiment was a mixture of 4 M of HBr and 0.5 M NaBr. To 1 litre of this solution was added 12.5 grams of V₂O₃₍ₛ₎, this being allowed to dissolve at 25° C. with 400 μm stirring speed. The reaction was faster than what it was predicted but this behaviour is found to be due to the oxidation of the vanadium trioxide powder, which was not stored in an oxygen-free atmosphere container for a few weeks before use. The V(III) had been oxidized by air to V(IV) and since V(IV) is fairly soluble in acid solution, the dissolution reaction was faster. The colour obtained after dissolution was slightly blue, which is the colour of V⁴⁺ in acid, while the colour of [V³⁺] is very dark green. Therefore, this measurement is not an accurate measure of the V₂O₃ dissolution rate. Other experiment was thus carried out by dissolving fresh vanadium trioxide in HBr solution, previously stored in a sealed container. It was found that the vanadium trioxide powder did not display significant dissolution in HBr even at elevated temperature.

### EXAMPLE 10

In the investigation of the vanadium pentoxide chemical dissolution in Br⁻ solution, a motor rotator and speed controller system were used to give a constant stirring speed. A glass propeller was connected to the motor rotator. In this system, the reactants were submerged in the water bath until the water level in water was higher than the level of the reactants in the reaction vessel. The temperature of the reactants was kept constant by a temperature controller.

After addition of the V₂O₅ powder, solution samples were taken every minute for 10 minutes followed be every 10 minutes thereafter up to 90 minutes. The samples were stored in close sample tubes. To avoid the transfer of undissolved powder, the syringes used to take the sample in the pre-determined time intervals were fitted with micro filters. This sampling technique was found to provide accurate data

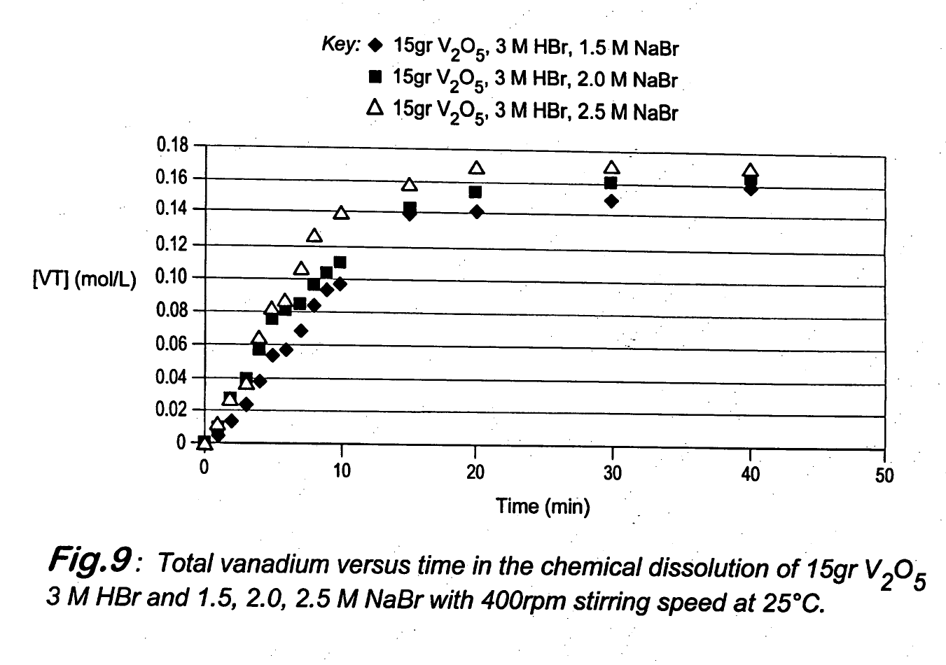

Three solutions with initial Br concentration of 4.5 M, 5 M, and 5.5 M and mixed with the same concentration of H⁺, which was kept constant at 3 M. All experiments were done at 25° C. and with 400 rpm stirring speed. The data obtained are presented in FIG. 9.

The reaction of the chemical dissolution process can be described by the following:

$$\frac{2 {Br}_{( aq )}^{-} ⇔ {Br}_{2 ( g )} + 2 {e}^{-} \\ 6 {H}_{( aq )}^{+} + {V}_{2} {O}_{5 ( s )} + 2 {e}^{-} ⇔ 2 {VO}_{( aq )}^{2 +} + 3 {H}_{2} {O}_{( 1 )}}{6 {H}_{( aq )}^{+} + {V}_{2} {O}_{5 ( s )} + 2 {Br}_{( aq )}^{-} ⇔ 2 {VO}_{( aq )}^{2 +} + 3 {H}_{2} {O}_{( 1 )} + {Br}_{2 ( g )}}$$

### EXAMPLE 11

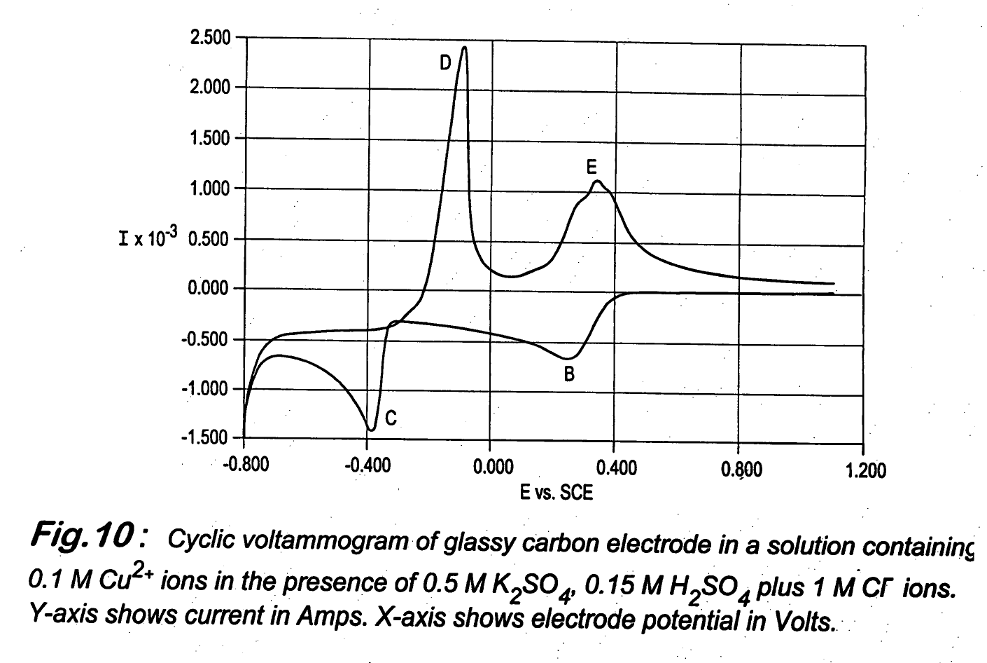

FIG. 10 shows a cyclic voltammogram obtained on a glassy carbon working electrode in a solution containing 0.1 M Cu²⁺ ions in the presence of 0.5 M K₂SO₄, 0.15 M H₂SO₄ plus 1 M Cl⁻ ions. The cathodic peak is associated with the reduction of Cu²⁺ ions to Cu⁺ with further reduction to Cu metal occurring at peak C. On reversal of the potential scan at −0.8 V, the oxidation of Cu metal to Cu⁺ occurs at anodic peak D, followed by oxidation of Cu⁺ to Cu²⁺ at peak E. Further scanning to an anodic potential of 1.1 V shows no further oxidation or reduction cycles.

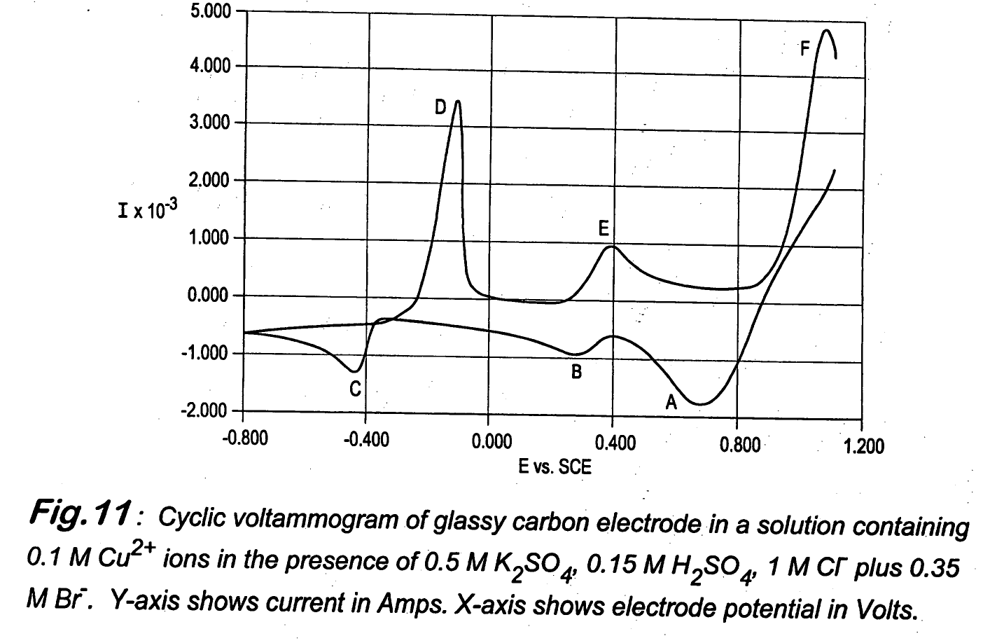

When 0.35 M Br⁻ ions were added to the above solution, the cyclic voltammogram of FIG. 11 was obtained. In contrast to FIG. 10, a new anodic peak is observed at 1 V, this being associated with the oxidation of Br to the polyhalide ion Br₂Cl⁻ or to Br₃⁻. Reversal of the anodic scan at 1 Volt shows a new cathodic peak produced by the reduction of the polyhalide ion to Br⁻.

The above results therefore show that the C(I)/Cu(II) couple is reversible in the presence of Br⁻, as is the Br⁻/Br₂Cl⁻ couple in the presence of Cu(II) ions. The potential difference between the two couples is seen to be approximately 0.7 Volts, indicating that a redox cell comprising these two couples should exhibit a cell voltage of 0.6 to 0.8 Volts which would-make it viable for energy storage applications.

### EXAMPLE 12

A 3 M CuBr₂ solution was prepared by dissolving 3 moles of CuO in 1 litre of 8 M HBr and 60 ml of this solution was placed into each half-cell of a Cu/Br redox flow cell that employed a Gore Select P-03430 membrane and graphite felt electrodes of area 25 cm². The cell was initially charged to a voltage of 1.0 V at a constant current of 2 Amps and discharged to a lower voltage limit of 0.2 V at a constant current of 1.0 Amp. The average charge voltage was 0.6 V while the discharge voltage was 0.4 V. The coulombic efficiency measured was less that 60%, but this was due to the air oxidation of the Cu(I) to Cu(II) in the charged negative half-cell. By excluding air from the negative half-cell, the coulombic efficiency can be increased significantly.

### EXAMPLE 13

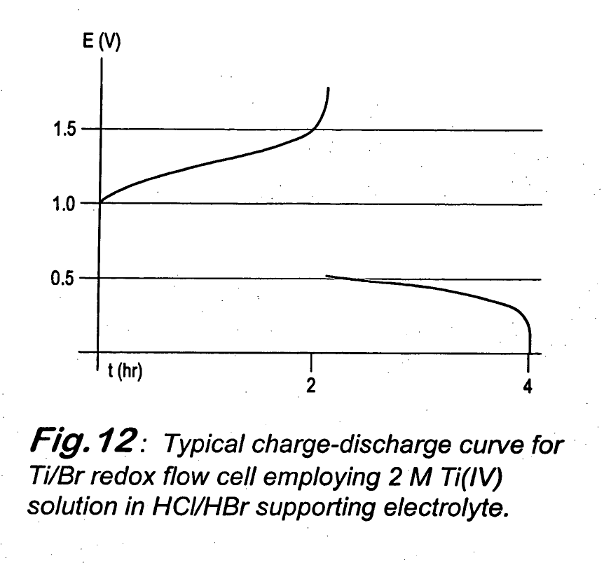

A titanium bromide redox flow cell was tested with a 2 M Ti(IV) chloride solution in 3 M HCl plus 4 M HBr. FIG. 12 shows a typical charge-discharge curve at a current of 1 Amp. From the ratio of the discharge time to charge time, the coulombic efficiency is calculated at approximately 88%. The average discharge voltage at this current is approximately 0.5 V, however with improved cell design and cell materials, the ohmic losses could be reduced so that a much high discharge voltage between 0.8 and 1.0 V could be expected.

### EXAMPLE 14

A Mo(IV) bromide electrolyte for a Molybdenum Bromide redox flow cell is prepared by suspended powder electrolysis of MoO₃ in a supporting electrolyte of 8M HBr plus 1.5 M HCl. The required amount of powder is introduced into the negative half-cell of an electrolysis cell that employs a graphite electrodes on each side and a Gore Select ion exchange membrane. A current of 20 mA/cm² is passed through the cell while nitrogen gas is bubbled through the negative half-cell to keep the MoO₃ powder suspended. The electrolysis should be continued for 10% more than the theoretical time needed to convert the Mo(VI) to the Mo(IV) oxidation state. At the end of the electrolysis, the resultant Mo(IV) solution is filtered and placed into both sides of a redox flow cell that employs a Gore Select membrane and 25 cm² graphite felt electrodes compressed against graphite plate current collectors. Copper plates are used at both ends to reduce the ohmic resistance through the graphite current collectors.

Into each electrolyte reservoir is placed 60 mls of the Mo(IV) solution in HBr/HCl and the cell charge-discharge cycled at a current of 1 to 2 Amps. An average discharge voltage of between 0.8 and 0.5 V can be obtained.

### BEST MODE OF OPERATION

A 3 M V(IV) bromide solution in 3-4 M HBr or HBr/HCl mixture is added to both sides of the redox flow cell or battery. On fully charging the cell, the vanadium (IV) bromide solution is reduced to produce 3M VBr₂ in the negative half-cell, while the bromide ions in the positive half-cell are oxidised to produce 1.5 M Br₃⁻ or ClBr₂⁻. On discharge, the VBr₂ is oxidised to VBr₃ in the negative half cell while the Br₃⁻ or ClBr₂⁻ ions are reduced to Br⁻ ions in the positive half cell. The cell comprises carbon or graphite felt bonded onto plastic or conducting plastic sheets as substrate materials and the two half cells are separated by an anion or cation exchange membrane such as Nafion 112 (Du Pont), New Selemion (Asahi Glass Co, Japan), Gore Select P-03430 (W. L. Gore), or Tokuyama AFN-R membrane (Japan). The two half-cell electrolytes are stored in external tanks and are pumped through the cell stack to allow the charging and discharging reactions to occur. Any gaseous bromine from the cell is bubbled through a solution of HBr or NaBr where it is complexed to form the polybromide or polyhalide species that can later be recycled to the cell.

1. A metal halide redox flow cell comprising:
a negative half-cell having:
an electrolyte containing a two valency state metal redox couple and
a positive half-cell having:
an electrolyte containing halide redox couple;
wherein the positive half-cell electrolyte also contains:
a halide of the said metal to provide substantial equilibrium of metal ion migration between the half cells.

2. A redox flow cell as claimed in claim 1, wherein the metal is chosen from the group consisting of vanadium, copper, molybdenum, manganese, tin and titanium.

3. A redox flow cell as claimed in claim 2, wherein the two valency state metal redox couple is chosen from the group consisting of the V(II)/V(III) couple, the Cu(I)/Cu(II) couple, the Mo(II)/Mo(III) couple, the Mn(II)/Mn(III) couple, the Sn(II)/Sn(IV) couple and the Ti(III)/Ti(IV) couple.

4. A redox flow cell as claimed in claim 1, wherein the halide redox couple comprises bromine.

5. A redox flow cell as claimed in claim 4, wherein the halide redox couple comprises one or more (as mixtures) of the following halide and polyhalide/halide redox couples
Br₃⁻/Br⁻,
ClBr₂⁻/Br⁻,
BrCL₂³¹ /Cl⁻.

6. A redox flow cell as claimed in claim 5, wherein the halide redox couple comprises Br₃⁻/Br⁻ and a supporting electrolyte in each half-cell comprises HBr, NaBr, KBr or mixtures thereof in a concentration range from 0.1 M to 12 M.

7. A redox flow cell as claimed in claim 5, wherein the halide redox couple comprises ClBr₂⁻/Br⁻ or BrCL₂⁻/Cl⁻ and a supporting electrolyte in each half-cell comprises HCI, NaCl or KCl or mixtures thereof in a concentration range from 0.5 M to 6 M to form stable polyhalides with the bromine that is formed in the positive half-cell during charging.

8. A redox flow cell as claimed in claim 4, wherein said method is chosen from the group consisting of vanadium, copper, molybdenum, manganese, tin and titanium and the concentration of said metal bromides in the negative and positive half-cell electrolytes is from 0.1 M to 6 M.

9. A redox flow cell as claimed in claim 8, wherein the concentration of said metal bromides in the negative and positive half-cell electrolytes is from 0.5 M to 5 M.

10. A redox flow cell as claimed in claim 9, wherein the concentration of said metal bromides in the negative and positive half-cell electrolytes is from 1 M to 4 M.

11. A redox flow cell as claimed in claim 5, wherein the concentration of Br₃⁻, Br₂Cl⁻ and/or Cl₂Br⁻ ions in the positive half cell of the fully charged vanadium, copper, molybdenum, manganese, tin or titanium bromide redox flow cell is between 0.1 M to 5 M.

12. A redox flow cell as claimed in claim 11, wherein the concentration of Br₃⁻, Br₂Cl⁻ and/or Cl₂Br⁻ ions in the positive half cell of the fully charged vanadium, copper, molybdenum, manganese, tin or titanium bromide redox flow cell is between 1 M to 3 M.

13. A redox flow cell as claimed in claim 4, including a solution of 0.1 M to 5 M charged vanadium, copper, molybdenum, manganese, tin or titanium bromide in both half-cells.

14. A redox flow cell as claimed in claim 2, wherein the metal is vanadium and when the cell is discharged, the vanadium in the negative half-cell is in V(III) and/or V(IV) state in a supporting electrolyte selected from the group consisting of HBr, NaBr, KBr and mixtures thereof and the vanadium in the positive half-cell is in V(IV) and/or V(V) state also in a supporting electrolyte selected from the group consisting of HBr, NaBr, KBr and mixtures thereof.

15. A redox flow cell as claimed in claim 14, wherein the positive and negative half cell electrolytes also contain chloride ions at a concentration of 0.1 M to 5 M.

16. A method of producing a metal halide redox flow cell comprising a negative half-cell having an electrolyte containing a two-valency-state metal redox couple and a positive half-cell having an electrolyte containing halide redox couple and a halide of the said metal, the method consisting in the steps of:
adding to both half cells:
a solution of a salt of a halide&of the said metal and
a supporting electrolyte comprising hydro-halic acid and/or a salt of one or more Group I metal halide(s) and
charging the cell.

17. A method as claimed in claim 16, wherein the metal is chosen from the group consisting of vanadium, copper, molybdenum, manganese, tin and titanium.

18. A method as claimed in claim 16, wherein the metal in the halide salt of the said metal as added in the second step is in a higher valency state than its two valency states in its redox couple.

19. A method as claimed in claim 18, wherein said metal is vanadium and its redox couple valency states are V(II)V(III) and its said higher valency state is V(IV).

20. A method as claimed in claim 18, wherein said salt is a vanadium bromide.

21. A method as claimed in claim 20, wherein the solution is of 0.1 M to 5 M V(IV) bromide.

22. A method as claimed in claim 16, wherein the supporting electrolyte comprises hydrobromic acid, sodium bromide or potassium bromide or mixtures thereof.

23. A method as claimed in claim 22, wherein the supporting electrolyte includes hydrochloric acid, sodium chloride or potassium chloride or mixtures thereof.

24. A redox flow cell produced by the method of claim 16, wherein the said two valency state metal is vanadium and during cycling of the cell, the negative half-cell electrolyte comprises V(II), V(III) and/or V(IV) ions and the positive electrolyte comprises a bromide/polyhalide couple in the presence of V(IV) and/or V(V) ions.

25. A redox flow cell as claimed in claim 24, wherein, during cycling, the negative half-cell electrolyte contains VBr₂ and/or VBr₃ in a supporting electrolyte selected from the group HBr, NaBr, KBr, HCl, NaCl, KCl or mixtures thereof.

26. A redox flow cell as claimed in claim 25, wherein, during cycling, the negative half cell electrolyte solution comprises 0.5 M to 5 M VBr₃ and/or VBr₂ in 0.1 M to 10 M HBr or HCl/HBr or NaCl/HBr or KCl/HBr mixtures.

27. A redox flow cell provided by the method of claim 16, wherein, when discharged, the positive half-cell electrolyte solution that includes ions of the said metal in a mixture of Cl⁻ and Br⁻ of total concentration 1 M to 12 M; and, when charged, the positive half-cell electrolyte includes ions of the said metal in a solution containing 0.5 M to 5 M Br₃⁻ or Br₂Cl⁻ ions or mixtures thereof.

28. A redox flow cell as claimed in claim 25, wherein the negative half-cell electrolyte solution contains an excess bromide and chloride ion concentration of 0.1 M to 10 M.

29. A redox flow cell as claimed in claim 25, wherein the said two valency state metal is vanadium and the discharged or partially charged positive half-cell electrolyte solution comprises V(IV) and/or V(V) ions in a supporting electrolyte of HBr, NaBr, KBr or mixture, at a concentration of 0.5 M to 5 M vanadium ions in a mixture of 0.5 M to 12 M bromide and chloride ions.

30. A redox flow cell of claim 1, wherein the two half-cell electrolytes are separated by an ion exchange membrane which prevents the bulk mixing of the solutions in the two half cells as they are pumped through the cell.

31. A redox flow cell as-claimed in claim 30, wherein the ion exchange membrane is a cation exchange membrane adapted to allow the transfer of charge carrying H⁺, Na⁺ and/or K⁺ ions.

32. A redox flow cell as claimed in claim 31, wherein the ion exchange membrane is an anion exchange membrane adapted to allow the transfer of charge carrying H⁺ Br⁻ and/or Cl⁻ ions.

33. A redox flow cell as claimed in claim 31, wherein the ion exchange membrane is chosen from the group consisting of Nafion 112, Nafion 117, other Nafion cation exchange membranes, Gore Select membranes, Flemion membranes and Selemion CMV cation exchange membranes.

34. A redox flow cell as claimed in claim 1, including negative and positive electrodes of porous carbon or graphite felt, matte or cloth materials on a graphite, glassy carbon or conducting plastic substrate.

35. A redox flow cell as claimed in claim 1, wherein the positive electrode material is an oxide coated titanium metal sheet or expanded metal mesh.

36. An electrolyte solution for use in both half-cells of a vanadium bromide redox flow cell, the solution comprising 0.5 M to 5 M V(IV) bromide in a supporting electrolyte of HBr, NaBr, KBr or mixtures thereof.

37. An electrolyte solution as claimed in claim 36, including chloride ions at a concentration of 0.1 M to 5 M.

38. A negative half-cell, electrolyte solution for a vanadium bromide redox flow cell, comprising 0.5 M to 5 M VBr₂ and/or VBr₃ in a supporting electrolyte of HBr, NaBr, KBr or mixtures thereof.

39. A negative half-cell electrolyte solution as claimed in claim 38, including Cl⁻ ions at a concentration of 0.1 M to 5 M.

40. A negative half-cell electrolyte as claimed in claim 39, in which there is an excess bromide and chloride ion concentration of 0.1 M to 10 M.

41. A discharged or partially charged positive half-cell electrolyte solution for vanadium bromide redox flow cell, comprising V(IV) and/or V(V) ions in a supporting electrolyte of HBr, NaBr, KBr or mixture thereof.

42. A positive half-cell electrolyte as claimed in claim 41, wherein the concentration is of 0.5 M to 5 M vanadium ions in a mixture of 0.5 M to 12 M bromide and chloride ions.

43. A method for producing an electrolyte for a vanadium bromide redox, comprising the steps of mixing of equimolar amounts of a V(III) compound with a V(V) compound in a solution of HBr, NaBr, KBr or mixtures thereof and stirring until fully dissolved.

44. A method as claimed in claim 43, wherein the V(III) compound is V₂O₃ and the V(V) compound is V₂O₅.

45. A method as claimed in claim 43, wherein said solution also contains chloride ions.

46. A redux flow cell as claimed in claim 6, wherein said concentration range is 0.1 M to 8 M.

47. A redux flow cell as claimed in claim 12, wherein said concentration range is 1 M to 2 M.

48. A method as claimed in claim 22, wherein the concentration of the hydrobromic acid, sodium bromide or potassium bromide or mixture thereof is 0.5 M to 10 M.

49. A method according to claim 23, wherein the concentration of the hydrochloric acid, sodium chloride or potassium chloride or mixtures thereof is 0.1 M to 5 M.

50. A redux flow cell as claimed in claim 28, wherein the excess bromide and chloride ion concentration is 0.1 M to 5 M.

51. A negative half-cell electrolyte as claimed in claim 40, wherein said concentration is 0.1 M to 5 M.
